(19) United States
(12) Patent Application Publication
(10) Pub. No.: US 2012/0084401 A1
(43) Pub. Date: Apr. 5, 2012

(54) COMMUNICATION APPARATUS, CONTROL METHOD THEREOF, AND NON-TRANSITORY COMPUTER-READABLE STORAGE MEDIUM

(75) Inventor: Masahiro Handa, Tokyo (JP)

(73) Assignee: CANON KABUSHIKI KAISHA, Tokyo (JP)

(21) Appl. No.: 13/224,964

(22) Filed: Sep. 2, 2011

(30) Foreign Application Priority Data
Sep. 30, 2010 (JP) 2010-222433

(51) Int. Cl. G06F 15/16

(52) U.S. Cl. 709/219

(57) ABSTRACT

A communication apparatus, which communicates with another communication apparatus via a server, requests the server to obtain a transmission authority required to exclusively transmit data to the other communication apparatus. When the transmission authority is obtained from the server in response to the request, the communication apparatus transmits data to the other communication apparatus. When the transmitted data is first data which is played back by the other communication apparatus after completion of transmission of the data, the communication apparatus requests the server to release the transmission authority after an elapse of a predetermined time since completion of transmission of the data.

### BACKGROUND OF THE INVENTION

1. Field of the Invention

The present invention relates to a communication apparatus, control method thereof, and non-transitory computer-readable storage medium.

2. Description of the Related Art

For example, a technique for distributing data to a plurality of communication partners using a half-duplex communication such as Push To Talk® (to be abbreviated as PTT hereinafter) or Push To Talk over Cellular/Wireless (to be abbreviated as PoC/W hereinafter) is known.

The PTT and PoC/W are known as communication modes which use, for example, a plurality of mobile phones like transceivers. In the PTT and PoC/W, a group is formed with mobile phones of partners, and common information can be simultaneously transmitted to a plurality of mobile phones in the group on a communication network.

In the PTT and PoC/W, only a user who requests a data distribution authority and then obtains the distribution authority can talk within a predetermined time since obtainment of the data distribution authority. That is, in the PTT and PoC/W, the data distribution authority has to be obtained to distribute a voice, and the voice cannot be distributed to other voice communication participants unless the data distribution authority can be obtained. Note that in the PTT and PoC/W modes, a technique for distributing not only voice communication data but also contents data such as still image, moving image, and music data has also be proposed (Japanese Patent Laid-Open Nos. 2006-080654 and 2007-134989).

In the PTT and PoC/W, as described above, contents data such as still image, moving image, and music data can be distributed, as described above. However, at the time of distribution of such data, the following problem is posed unlike in a case of real-time video and voice data.

For example, when the data distribution authority is released immediately after contents data is distributed, and when another participant obtains the data distribution authority soon, the distributed data is updated to the other participant soon. For example, when a plurality of still images are successively distributed, if the still images are displayed at different intervals in receiving apparatuses, a plurality of users cannot simultaneously view the same still image.

In order to solve this problem, a method which allows a user who distributes contents data to operate a mobile phone to execute data distribution authority control and sync control of contents data to be viewed is available. However, this method requires complicated operations for the user, thus imposing an operation load on the user.

Also, a utility form in which data provided from another apparatus is distributed to a plurality of mobile phones via a mobile phone in a PTT or PoC/W communication mode is available. For example, when data in an image sensing apparatus is distributed to another mobile phone, the user operates the image sensing apparatus to select contents data to be distributed, and then operates the mobile phone to execute the aforementioned data distribution authority control and sync control, resulting in troublesome operations.

### SUMMARY OF THE INVENTION

The present invention provides a technique for improving user's convenience upon distributing contents data (for example, still image, moving image, and music data) in a PTT (PoC/W) mode.

According to a first aspect of the present invention there is provided a communication apparatus, which communicates with another communication apparatus via a server, comprising: a first request unit configured to request the server to obtain a transmission authority required to exclusively transmit data to the other communication apparatus; a transmission unit configured to transmit, when the transmission authority is obtained from the server in response to the request by the first request unit, data to the other communication apparatus; and a second request unit configured to request, when the data transmitted by the transmission unit is first data which is played back by the other communication apparatus after completion of transmission of the data, the server to release the transmission authority after an elapse of a predetermined time since completion of transmission of the data.

According to a second aspect of the present invention there is provided a control method of a communication apparatus, which communicates with another communication apparatus via a server, the method comprising: requesting the server to obtain a transmission authority required to exclusively transmit data to the other communication apparatus; transmitting, when the transmission authority is obtained from the server in response to the request, data to the other communication apparatus; and requesting, when the transmitted data is first data which is played back by the other communication apparatus after completion of transmission of the data, the server to release the transmission authority after an elapse of a predetermined time since completion of transmission of the data.

Further features of the present invention will be apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing an example of the overall arrangement of a communication system according to an embodiment of the present invention;

FIG. 2 is a block diagram showing an example of the functional arrangement of an image sensing apparatus 10 shown in FIG. 1;

FIG. 3 is a flowchart showing an example of the sequence of processing of the image sensing apparatus 10 shown in FIG. 1;

FIG. 4 is a flowchart showing an example of the sequence of data transmission processing in step S111 in FIG. 3;

FIG. 5 is a flowchart showing another example of the sequence of the data transmission processing in step S111 in FIG. 3;

FIG. 6 is a flowchart showing an example of the sequence of data distribution authority obtainment waiting processing in step S110 in FIG. 3; and

FIG. 7 is a flowchart showing an example of the sequence of processing of an image sensing apparatus 10 according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

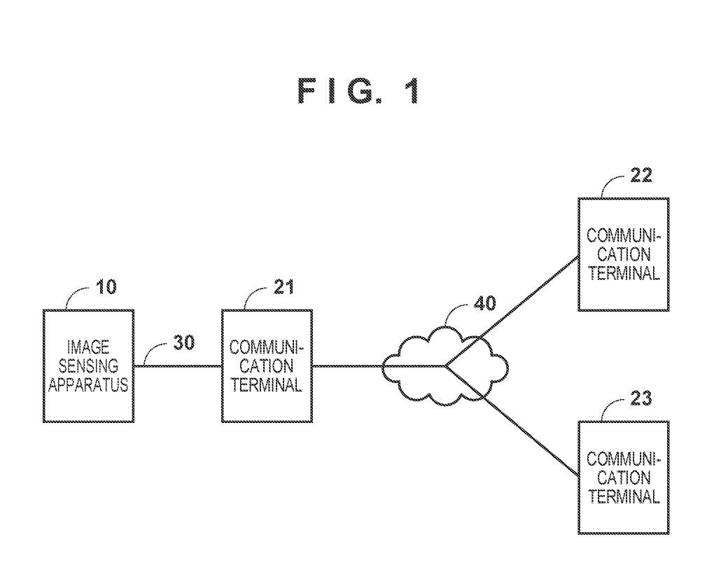

FIG. 1 is a block diagram showing an example of the overall arrangement of a communication system according to an embodiment of the present invention.

The communication system includes an image sensing apparatus 10 and a plurality of communication terminals 21 to 23. In this case, the image sensing apparatus 10 and communication terminal 21 are connected to be able to make data communications via, for example, a wired/wireless LAN or Bluetooth. The plurality of communication terminals 21 to 23 are connected to be able to make data communications via, for example, the Internet or a mobile phone network. Note that this embodiment will exemplify a case in which the image sensing apparatus 10 and communication terminal 21 are connected via a network 30, and the plurality of communication terminals 21 to 23 are connected via a mobile phone network 40.

The image sensing apparatus 10 functions as a data providing apparatus, and provides, for example, various kinds of data to the communication terminal 21. More specifically, the image sensing apparatus 10 provides real-time data (for example, video and voice data) and contents data (for example, still image, moving image, and music data) to the communication terminal 21. These data are distributed to, for example, the communication terminals 22 and 23 via the communication terminal 21.

The image sensing apparatus 10 communicates with the communication terminal 21 via the network 30, and distributes data to the communication terminals 22 and 23 via the communication terminal 21. Note that in this embodiment, the image sensing apparatus 10 distributes data to the communication terminals 22 and 23 via the communication terminal 21. Alternatively, the image sensing apparatus 10 may be directly connected to the mobile phone network 40 to make PTT (PoC/W) communications with the communication terminals 22 and 23, thus distributing data to these terminals.

The communication terminal 21 is, for example, a mobile phone, PDA, or smart phone, and makes PTT (PoC/W) communications with other communication terminals 22 and 23 via the mobile phone network 40.

The plurality of communication terminals 21 to 23 make PTT (PoC/W) communications via the mobile phone network 40. The PTT communication is a communication mode, in which only a terminal, which obtains a data distribution authority, of a plurality of terminals can exclusively distribute data to other terminals. Note that the PTT (PoC/W) communication may be implemented using a PTT (PoC/W) server. Alternatively, the PTT (PoC/W) communication may be implemented using means such as P2P (Peer to Peer communication).

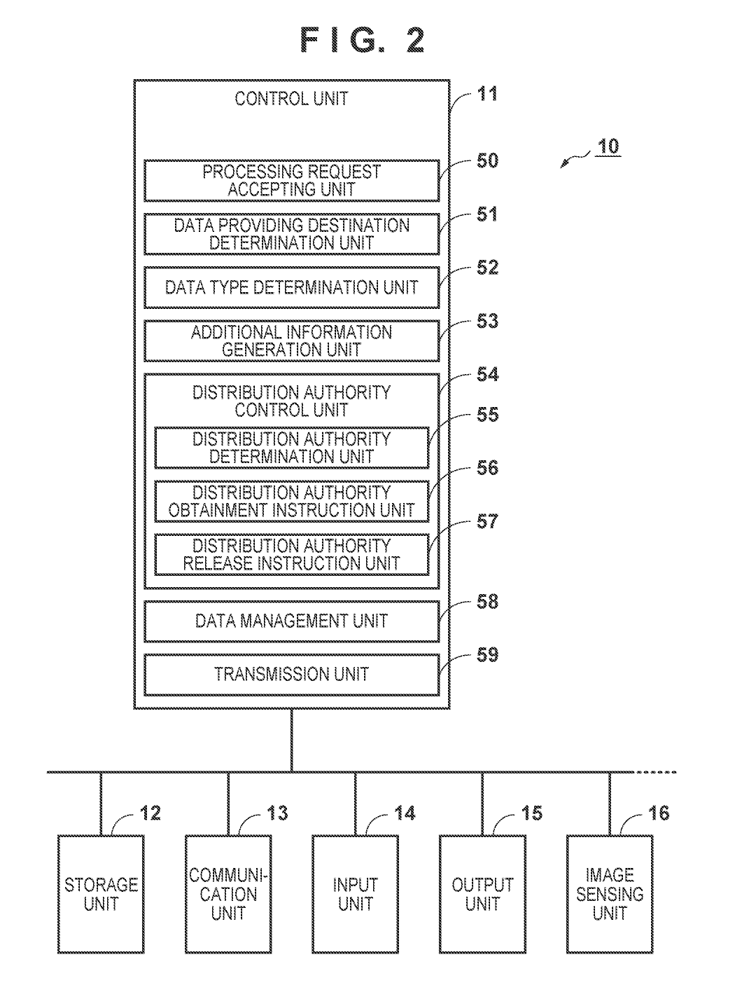

An example of the functional arrangement in the image sensing apparatus 10 will be described below with reference to FIG. 2.

The image sensing apparatus 10 includes, as its functional arrangement, a control unit 11, storage unit 12, communication unit 13, input unit 14, output unit 15, and image sensing unit 16.

The image sensing unit 16 is implemented by, for example, a CCD (Charge-Coupled Device) or CMOS (Complementary Metal Oxide Semiconductor), and senses an image. The storage unit 12 is implemented by, for example, a ROM (Read Only Memory) and RAM (Random Access Memory), and stores various kinds of information.

The input unit 14 is implemented by, for example, buttons and the like, and inputs instructions from the user to the apparatus. The output unit 15 is implemented by, for example, a liquid crystal display, and displays various kinds of information for the user. Note that the input unit 14 and output unit 15 may be implemented as, for example, a touch panel.

The communication unit 13 is implemented by, for example, a network card, and communicates with the communication terminal 21 via the network 30. This communication uses, for example, a TCP/IP protocol. Note that when the image sensing apparatus 10 is directly connected to the mobile phone network 40 to communicate with the communication terminals 22 and 23, the communication unit 13 executes processing compliant with a protocol that implements PTT (PoC/W).

The control unit 11 is implemented by, for example, a CPU and the like, and systematically controls the processing in the image sensing apparatus 10. In this case, the control unit 11 includes a processing request accepting unit 50, data providing destination determination unit 51, data type determination unit 52, additional information generation unit 53, distribution authority control unit 54, data management unit 58, and transmission unit 59. Note that the respective units in the control unit 11 are implemented, for example, when the CPU (Central Processing Unit) reads out and executes programs stored in the ROM and the like.

The data providing destination determination unit 51 determines whether or not a data providing destination is a terminal compatible with a PTT (PoC/W) communication mode. When a terminal as the data providing destination is compatible with the PTT (PoC/W) communication mode, the determination unit 51 also determines whether or not the PTT (PoC/W) communication mode is active. Note that whether or not the data providing destination is a terminal compatible with the PTT (PoC/W) communication mode and whether or not the PTT (PoC/W) communication mode is active are determined based on, for example, inquiries sent to a terminal as the data providing destination. Also, whether or not the data providing destination is a terminal compatible with the PTT (PoC/W) communication mode may be determined by holding a list of terminals compatible with the PTT (PoC/W) communication mode in the storage unit 12 in advance, and referring to that list.

The data type determination unit 52 determines a type of data to be provided. More specifically, the determination unit 52 determines whether data to be provided is first data which is to be played back in real-time simultaneously with the beginning of the data distribution or second data which is not to be played back in real-time simultaneously with the beginning of the data distribution. The first data includes real-time data (for example, video and voice data), and the second data includes contents data (for example, still image, moving image, and music data).

The additional information generation unit 53 generates information (additional information) to be appended to contents data (second data) when that data is transmitted to the communication terminal 21. In the additional information, a release timing of a data distribution authority by the communication terminal 21, and information required to change a data distribution timing are specified. In this embodiment, in the additional information, for example, a playback time of contents data and information required to identify a type of the contents data are specified.

The distribution authority control unit 54 has a function of executing control associated with a data distribution authority, and includes a distribution authority determination unit 55, distribution authority obtainment instruction unit 56, and distribution authority release instruction unit 57. The distribution authority determination unit 55 determines whether or not the communication terminal 21 has obtained a data distribution authority. The distribution authority obtainment instruction unit 56 instructs the communication terminal 21 to obtain a data distribution authority. The distribution authority release instruction 57 instructs the communication terminal 21 to release the data distribution authority. Note that when the image sensing apparatus 10 directly makes PTT communications with the communication terminals 22 and 23, it sends obtainment and release requests of the data distribution authority to, for example, the PTT server.

The processing request accepting unit 50 accepts a data providing request. The data providing request is issued based on, for example, an instruction input from the user via the input unit 14. Note that when the user presses a release button or an imaging start button, such action may be accepted as a data providing request.

The data management unit 58 manages data to be provided using a queue (transmission queue). The transmission unit 59 transmits (provides) one or a plurality of data to the communication terminal 21. Note that when the image sensing apparatus 10 directly makes PTT communications, it distributes data to the PTT server or the communication terminals 22 and 23.

The example of the functional arrangement in the image sensing apparatus 10 has been explained. Note that the image sensing apparatus 10 includes the image sensing unit 16 since it is explained as the data providing apparatus, but this component is not always indispensable. A description of the functional arrangement of the communication terminals 21 to 23 will not be given, but each of these terminals incorporates a computer including a CPU, ROM, RAM, and the like as in the image sensing apparatus 10.

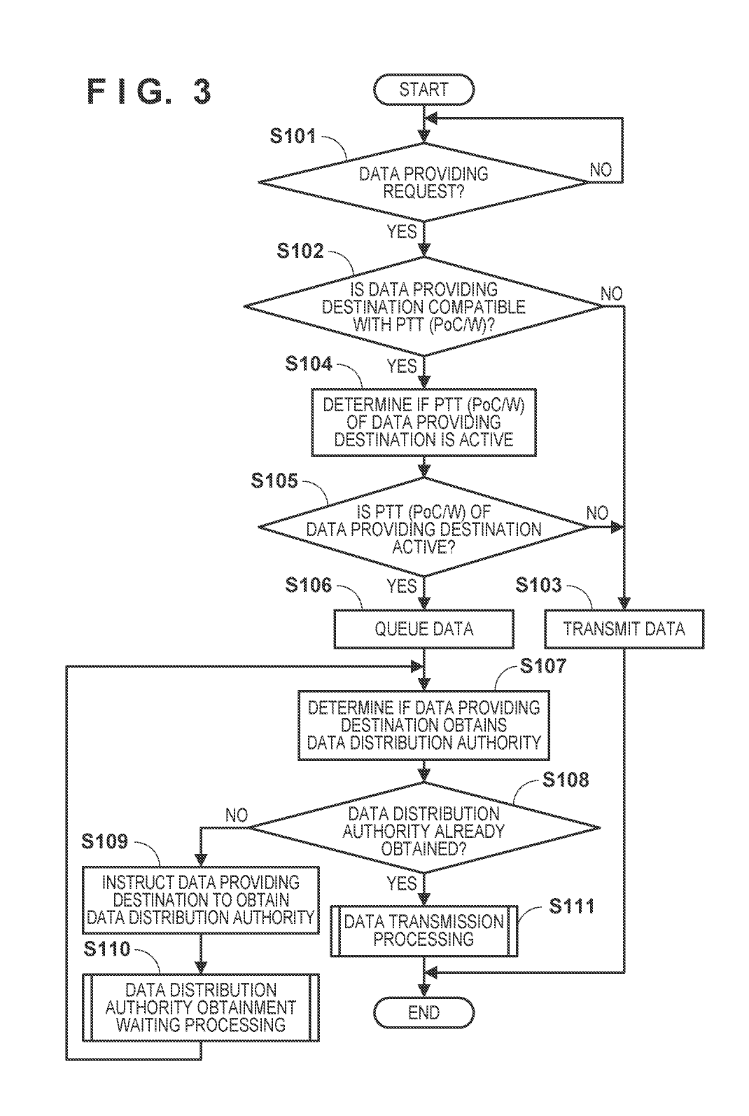

An example of the sequence of processing in the image sensing apparatus 10 shown in FIG. 1 will be described below with reference to FIG. 3. In this case, the sequence of processing executed when data is provided (transmitted) toward a terminal as a data providing destination will be described.

When the image sensing apparatus 10 accepts a data providing request at the processing request accepting unit 50 (YES in S101), it starts this processing. For example, when the user designates target data, the image sensing apparatus 10 accepts it as a data providing request. Target data to be provided includes, for example, contents data (for example, image, video, and music data) in a memory (for example, the storage unit 12) of the image sensing apparatus 10 or real-time data (for example, a voice and a video which is being sensed).

The image sensing apparatus 10 controls the data providing destination determination unit 51 to determine whether or not a data providing destination is a terminal compatible with the PTT (PoC/W) communication mode. In this embodiment, the determination unit 51 determines whether or not the data providing destination is the communication terminal 21. As a result of determination, if the data providing destination is not the communication terminal (NO in S102), the image sensing apparatus 10 controls the transmission unit 59 to transmit data to a terminal as the data providing destination (S103), thus ending this processing.

On the other hand, if the data providing destination is the communication terminal 21 (YES in S102), the image sensing apparatus 10 controls the data providing destination determination unit 51 to determine whether or not the PTT communication mode of the communication terminal 21 is active (S104). This determination is attained by sending an inquiry as to whether or not the PTT communication mode is active to the communication terminal 21.

As a result of the inquiry, if the PTT communication mode of the communication terminal 21 is not active (NO in S105), the image sensing apparatus 10 controls the transmission unit 59 to transmit data to a terminal as the data providing destination (S103), thus ending this processing. Note that when the PTT communication mode of the communication terminal 21 is not active, the image sensing apparatus 10 may instruct the communication terminal 21 to start a PTT communication.

If the PTT communication mode of the communication terminal 21 is active (YES in S105), the image sensing apparatus 10 controls the data management unit 58 to queue data to be provided (S106). Then, the image sensing apparatus 10 controls the distribution authority determination unit 55 to determine whether or not the communication terminal 21 has obtained a data distribution authority. This determination is attained by sending an inquiry about whether or not the data distribution authority has already been obtained to the communication terminal 21.

As a result of the inquiry, if the communication terminal 21 has not obtained the data distribution authority yet (NO in S108), the image sensing apparatus 10 controls the distribution authority obtainment instruction unit 56 to instruct the communication terminal 21 to obtain a data distribution authority (S109). As will be described in detail later, the image sensing apparatus 10 waits until the communication terminal 21 obtains the data distribution authority (S110). Note that the image sensing apparatus 10 may accept a data providing request for new data during this data distribution authority obtainment waiting state.

If it is determined in step S108 that the communication terminal 21 has obtained the data distribution authority (YES in S108), the image sensing apparatus 10 controls the transmission unit 59 to transmit the queued data to the communication terminal 21. In this processing (to be described in detail later), the image sensing apparatus 10 transmits data queued in the transmission queue in the order of queuing toward the communication terminal 21 (S111).

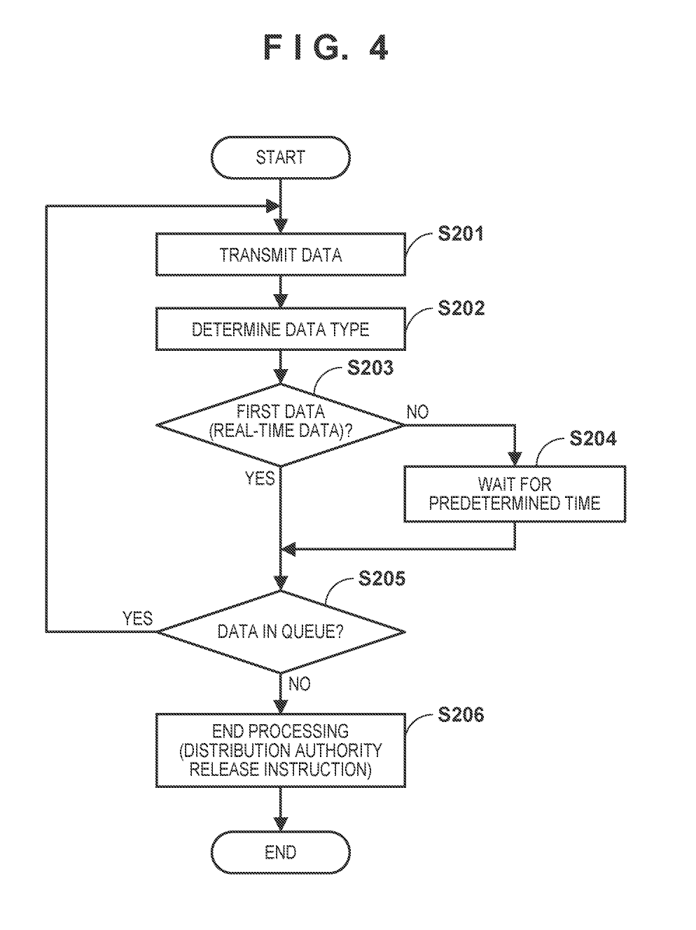

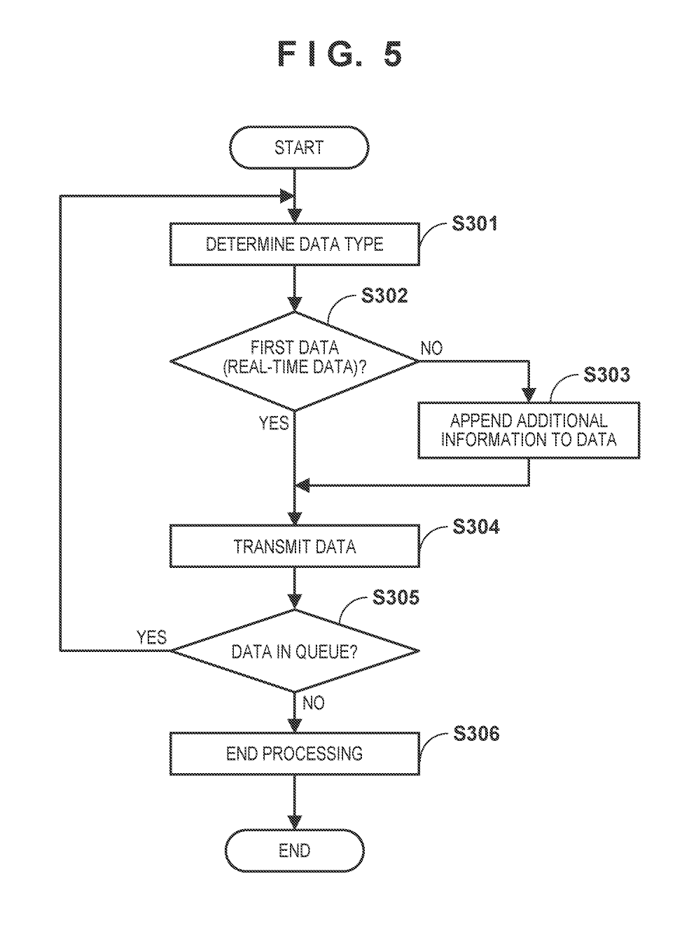

The data transmission processing in step S111 of FIG. 3 will be described below taking two different examples with reference to FIGS. 4 and 5. That is, a series of processes from data transmission until the data distribution authority is released will be explained.

The first data transmission processing will be described first with reference to FIG. 4. When this processing starts, the image sensing apparatus 10 controls the transmission unit 59 to transmit data to be provided toward the terminal as the data providing destination (S201). Then, the image sensing apparatus 10 controls the data type determination unit 52 to determine whether the data is first data which is to be played back in real-time simultaneously with the beginning of the data distribution by the communication terminal 21 or second data which is not to be played back in real-time (S202).

As a result of determination, if that data is not first data (that is, if that data is second data: NO in S203), the image sensing apparatus 10 waits for a predetermined time, and then determines whether or not data is queued in the transmission queue. This waiting time is set in advance in, for example, the image sensing apparatus 10.

In this case, when the image sensing apparatus 10 transmits still images in turn to the communication terminal 21 without executing such waiting processing, the following problem is posed. Since the communication terminal 21 as a data distribution source successively distributes a plurality of still images (that is, second data) received from the image sensing apparatus 10 to another terminal, the terminal which received the still images unwantedly updates and displays new still images one after another. Conventionally, in order to cope with this, the user has to distribute still images at longer data distribution intervals by operating the communication terminal 21. By contrast, in this embodiment, since the image sensing apparatus 10 automatically assures a waiting time to transmit data to the communication terminal 21 depending on the data type, the user can successively distribute, for example, a plurality of still images from the communication terminal 21 without making any special operations.

If it is determined in step S203 that the data is first data (YES in S203), the image sensing apparatus 10 determines, without waiting, whether or not data is queued in the transmission queue. If data is queued (YES in S205), the process returns to S201, and the image sensing apparatus 10 transmits the next queued data. Note that if no data is queued (NO in S205), the image sensing apparatus 10 controls the distribution authority release instruction unit 57 to instruct the communication terminal 21 to release the data distribution authority (S206), thus ending this processing.

The second data transmission processing will be described below with reference to FIG. 5. When this processing starts, the image sensing apparatus 10 controls the data type determination unit 52 to determine whether data to be provided is first or second data (S301).

As a result of determination, if the data is not first data (that is, if the data is second data: NO in S302), the image sensing apparatus 10 controls the additional information generation unit 53 to generate additional information and to append the additional information to the data (S303). Note that the additional information includes, for example, a playback time of data to be provided (contents data) and information required to identify a type of the data to be provided, as has been described above.

After that, the image sensing apparatus 10 controls the transmission unit 59 to transmit the data to the terminal as the providing destination (S304). Note that the communication terminal 21 which received the data including the additional information distributes the data to the communication terminals 22 and 23 at timings according to the additional information. For example, when the additional information includes a playback time of the data to be provided, the communication terminal 21 distributes next data to the communication terminals 22 and 23 (or releases the data distribution authority) after an elapse of the playback time. On the other hand, when the additional information includes the type of the data to be provided, and the type indicates second data, the communication terminal 21 distributes next data to the communication terminals 22 and 23 (or releases the data distribution authority) after an elapse of a time specified in advance. That is, according to the processing shown in FIG. 5, since the communication terminal 21 distributes data by assuring a waiting time according to the contents of the additional information, the user can successively distribute, for example, a plurality of still images from the communication terminal 21 without making any special operations as in the processing described using FIG. 4. Also, according to the processing shown in FIG. 5, no problem is posed when the power supply of the image sensing apparatus 10 can be turned off after it provides data.

On the other hand, as a result of determination in step S302, if the data is first data (YES in S302), the image sensing apparatus 10 controls the transmission unit 59 to transmit the data intact toward the terminal as the data providing destination (S304).

After that, the image sensing apparatus 10 determines whether or not data is queued in the transmission queue. If data is queued (YES in S305), the process returns to step S301 to determine a data type. Note that if no data is queued (NO in S305), the image sensing apparatus 10 executes end processing (S306), thus ending this processing.

The two different examples of the series of processes from data transmission until the data distribution authority is released have been described using FIGS. 4 and 5. Either of these methods may be used and, for example, operation setting information may include a setting about the method to be used. Note that the processing described using FIG. 4 is effective when the communication terminal as the data providing destination (communication terminal 21) cannot interpret the contents of the additional information. The processing described using FIG. 5 has a merit that the image sensing apparatus 10 can execute the end processing (for example, it can turn off its power supply) without any waiting time after transmission of data to the communication terminal 21.

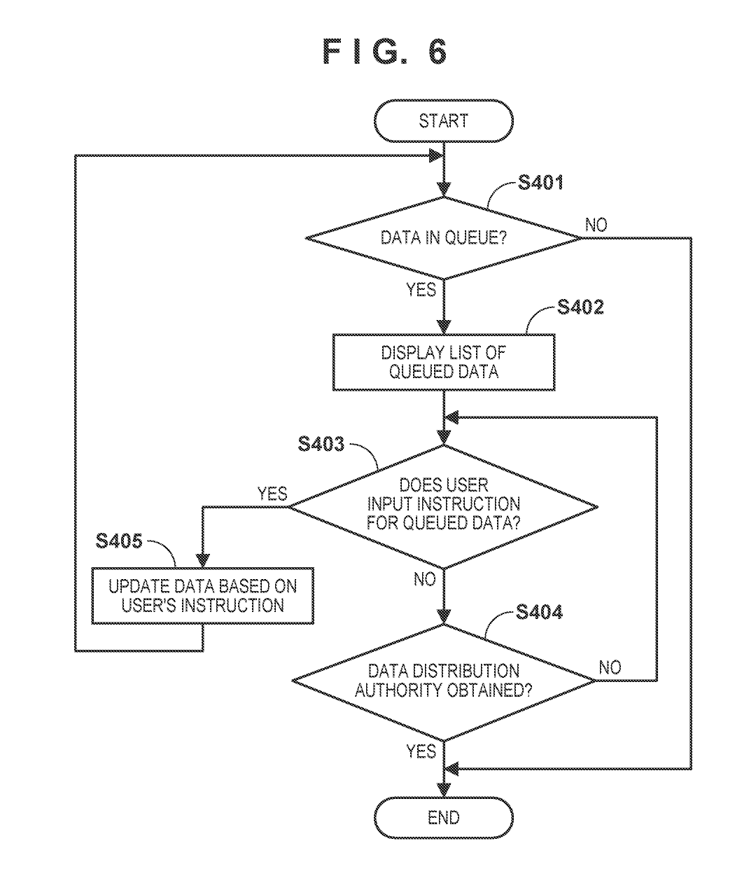

The data distribution authority obtainment waiting processing in step S110 of FIG. 3 will be described below with reference to FIG. 6.

When this processing starts, the image sensing apparatus 10 confirms whether or not data is queued in the transmission queue. If no data is queued (NO in S401), the image sensing apparatus 10 ends this processing. If data is queued (YES in S401), the image sensing apparatus 10 displays a list of queued data on a display device (output unit 15) (S402).

After the list is displayed, the image sensing apparatus 10 waits until the user inputs an instruction for queued data via the input unit 14 or the communication terminal 21 obtains the data distribution authority (NO in S404 after NO in S403). If the user instruction is input during this waiting time (S403), the image sensing apparatus 10 controls the data management unit 58 to update queued data based on that instruction, and the process returns to step S401. Note that the data updating processing includes, for example, transmission stop, transmission suspension, and transmission order change processes. If the communication terminal 21 obtains the data distribution authority during the waiting time in steps S403 and S404 (YES in S404), the image sensing apparatus 10 ends this processing.

In this manner, the image sensing apparatus 10 temporarily queues data to be provided in the transmission queue of itself before the communication terminal 21 obtains a data distribution authority. For this reason, the image sensing apparatus 10 never transmits data in turn to the communication terminal 21 before the communication terminal 21 obtains the data distribution authority. Hence, for example, a data cache capacity of the communication terminal 21 is never compressed due to data which have been transmitted in turn to the communication terminal 21 before the data distribution authority is obtained.

Also, since the image sensing apparatus 10 queues data, when the user wants to update data to be distributed (he or she wants to change the order of data), he or she can easily execute such data updating processing on the image sensing apparatus.

As described above, according to this embodiment, when data is provided to the communication terminal which is communicating in the PTT (PoC/W) mode, whether that data is first or second data is determined. Then, based on the determination result, a data distribution interval and a data distribution authority release timing are changed.

Thus, the aforementioned problem posed when second data (for example, still image, moving image, and music data) which is not to be played back in real-time simultaneously with the beginning of the data distribution is transmitted in the PTT (PoC/W) communication mode can be solved. Also, since no special operations are required for the user, the user's convenience can be improved.

### Second Embodiment

The second embodiment will be described below. The second embodiment will explain a case in which an image sensing apparatus 10 directly makes PTT communications with communication terminals 22 and 23. That is, the second embodiment will explain a case in which the image sensing apparatus 10 functions as a data distribution apparatus. Note that the arrangements of a communication system and the image sensing apparatus 10 according to the second embodiment are slightly different from the first embodiment, but they are roughly the same arrangements, and a description thereof will not be repeated. In this case, processes having largely different sequences will be mainly described.

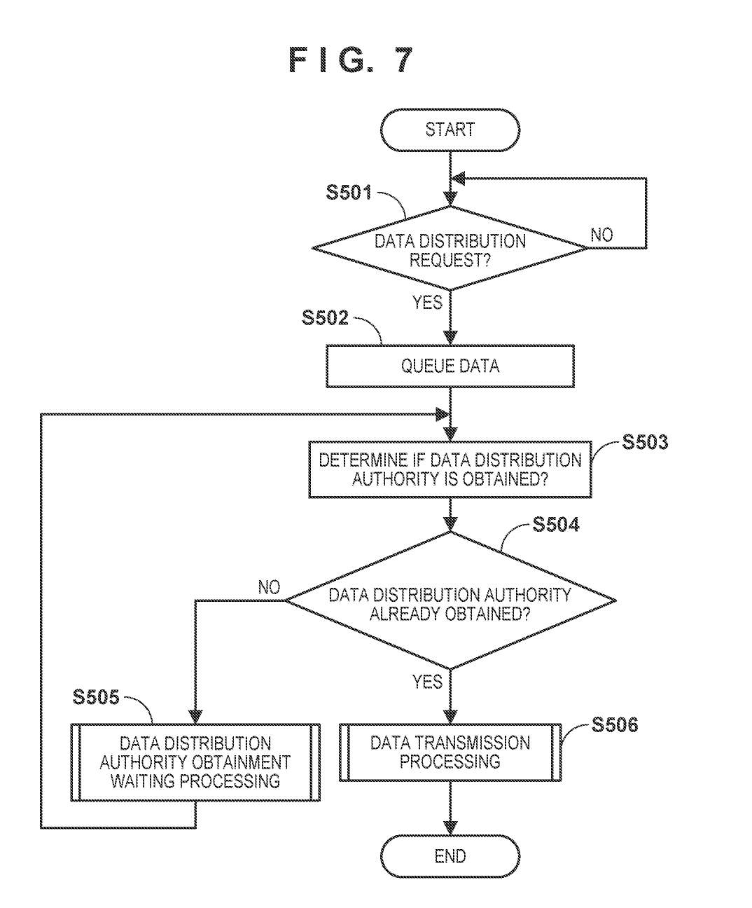

An example of the sequence of processing upon distributing data will be described below with reference to FIG. 7. When the image sensing apparatus 10 accepts a data distribution request at a processing request accepting unit 50 (YES in S501), it starts this processing.

When this processing starts, the image sensing apparatus 10 controls a data management unit 58 to queue data to be distributed (S502). The image sensing apparatus 10 then controls a distribution authority determination unit 55 to determine whether or not the self apparatus (image sensing apparatus 10) has obtained a data distribution authority (S503).

As a result of determination, if the self apparatus has not obtained the data distribution authority yet (NO in S504), the image sensing apparatus 10 waits to obtain the data distribution authority (S505). Note that this processing is the same as that in step S110 (that is, the processing in FIG. 6) used to explain the first embodiment, and a detailed description thereof will not be repeated.

On the other hand, if the self apparatus has obtained the data distribution authority (YES in S504), the image sensing apparatus 10 controls a transmission unit 59 to transmit the queued data toward other communication terminals (S506). Note that this processing is the same as that in step S111 (that is, the processing in FIGS. 4 and 5) used to explain the first embodiment, and a detailed description thereof will not be repeated. This processing will be briefly described below. When a plurality of data are to be successively distributed, next data is distributed after an elapse of a predetermined waiting time since the distribution of second data. When all data have been distributed, if data distributed last is second data, the data distribution authority is released after an elapse of a predetermined waiting time since the distribution of that data.

As described above, according to the second embodiment, when data is distributed in the PTT (PoC/W) mode, whether the data is first or second data is determined. Then, a data distribution interval and data distribution authority release timing are changed based on the determination result. In this case as well, the same effects as in the first embodiment can be obtained.

The representative embodiments of the present invention have been described. However, the present invention is not limited to the aforementioned and illustrated embodiments, and can be modified as needed without departing from its scope.

For example, the timing at which the data distribution authority obtainment instruction is issued to the communication terminal 21 as the data providing destination is not limited to that described in step S109 of FIG. 3. For example, when the user inputs an imaging start instruction using the image sensing unit 16 via the input unit 14, the data distribution authority obtainment instruction may be issued to the communication terminal 21.

In the examples of the first and second embodiments described above, the data providing apparatus (or data distribution apparatus) is the image sensing apparatus. However, the present invention is not limited to such specific examples. That is, various other apparatuses may be used as long as they can provide (or distribute) data to be distributed to other apparatuses (communication terminals and the like). For example, a personal computer may be used.

In the examples of the first and second embodiments described above, whether or not to assure a waiting time is decided according to the data type. However, the present invention is not limited to such specific examples. For example, whether or not to assure a waiting time may be decided in consideration of the characteristics of the communication terminals (communication terminals 22 and 23) with which the communication terminal 21 as the data providing destination makes communications in the PTT (PoC/W) mode, or the PTT server. For example, even when a plurality of second data (for example, still images) are to be successively transmitted, if the communication terminals 22 and 23 or the PTT server has specifications to perform playback operations by assuring a waiting time, the image sensing apparatus 10 can execute the same processing as that upon transmission of first data.

As described above, according to the present invention, the user's convenience upon distribution of contents data (for example, still image, moving image, and music data) in the PTT (PoC/W) mode can be improved.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-222433 filed on Sep. 30, 2010, which is hereby incorporated by reference herein in its entirety.

What is claimed is:

1. A communication apparatus, which communicates with another communication apparatus via a server, comprising:
a first request unit configured to request the server to obtain a transmission authority required to exclusively transmit data to the other communication apparatus;
a transmission unit configured to transmit, when the transmission authority is obtained from the server in response to the request by said first request unit, data to the other communication apparatus; and
a second request unit configured to request, when the data transmitted by said transmission unit is first data which is played back by the other communication apparatus after completion of transmission of the data, the server to release the transmission authority after an elapse of a predetermined time since completion of transmission of the data.

2. The apparatus according to claim 1, wherein when said transmission unit successively transmits a plurality of data to the other communication apparatus, and when it is determined that the transmitted data is the first data, said transmission unit transmits next data after an elapse of a predetermined time.

3. The apparatus according to claim 1, further comprising:
a determination unit configured to determine whether data to be transmitted by said transmission unit is the first data or second data which is played back in real-time simultaneously with the beginning of reception of the data in the other communication apparatus.

4. The apparatus according to claim 1, further comprising:
a reception unit configured to receive a plurality of data to be transmitted to the other communication apparatus from a providing apparatus together with additional information including a release timing of the transmission authority by said communication apparatus,
wherein said transmission unit transmits next data after an elapse of a predetermined time based on the additional information.

5. The apparatus according to claim 4, wherein the additional information is information which indicates at least one of a data playback time and a data type.

6. A control method of a communication apparatus, which communicates with another communication apparatus via a server, the method comprising:
requesting the server to obtain a transmission authority required to exclusively transmit data to the other communication apparatus;
transmitting, when the transmission authority is obtained from the server in response to the request, data to the other communication apparatus; and
requesting, when the transmitted data is first data which is played back by the other communication apparatus after completion of transmission of the data, the server to release the transmission authority after an elapse of a predetermined time since completion of transmission of the data.

7. A non-transitory computer-readable storage medium storing a computer program for controlling a computer to execute respective steps of claim 6.
